(19) United States
(12) Patent Application Publication
(10) Pub. No.: US 2018/0015488 A1
(43) Pub. Date: Jan. 18, 2018

(54) HYDROPHOBIC FINISHING APPARATUS OF FABRIC

(71) Applicant: CREATING NANO TECHNOLOGIES, INC., TAINAN CITY (TW)

(72) Inventors: Yen-Cheng CHEN, TAICHUNG CITY (TW); Min-Sheng YU, TAITUNG COUNTY (TW); Wen-Chiuan WU, Tainan City (TW); Yi-Ju WANG, Tainan City (TW); Huang-Wei CHEN, Tainan City (TW); Shih-Chang WANG, Tainan City (TW)

(21) Appl. No.: 15/649,617

(22) Filed: Jul. 13, 2017

(30) Foreign Application Priority Data
Jul. 15, 2016 (TW) 105210720

(51) Int. Cl. B05B 9/03; B05B 15/00; D06M 23/00

(52) U.S. Cl. CPC B05B 9/035; D06M 23/00; B05B 15/00; D06M 2200/12

(57) ABSTRACT

A hydrophobic finishing apparatus of a fabric is described. The hydrophobic finishing apparatus includes a first spray coating device, at least one first plasma device, a second spray coating device and at least one second plasma device. The first spray coating device is configured to spray a hydrophobic agent to a first side of the fabric. The first plasma device is disposed at the rear of the first spray coating device and is configured to perform a first plasma treatment on the first side of the fabric. The second spray coating device is disposed at the rear of the first plasma device and is configured to spray the hydrophobic agent to a second side of the fabric. The second plasma device is disposed at the rear of the second spray coating device and is configured to perform a second plasma treatment on the second side of the fabric.

### RELATED APPLICATIONS

This application claims priority to Taiwan Application Serial Number 105210720, filed Jul. 15, 2016, which is herein incorporated by reference.

### BACKGROUND

### Field of Invention

The present invention relates to a finishing apparatus of a fabric. More particularly, the present invention relates to a hydrophobic finishing apparatus of a fabric.

### Description of Related Art

Sharply rising of functional fabrics promotes the fading textile industry. The functional fabrics are fabric products developed according to requirements of people, in which leisure sport fabrics and biomedical fabrics are staple fabrics. For the past few years, as the quality of life of the nationals are promoted, many outdoor recreation activities are developed, and thus new revolution in outdoor functional clothing is started. The water repellent leisure sport fabrics are most common in the leisure sport fabrics.

To endow the fabrics with water repellent capability is one of fabric finishing processes. Most of the traditional fabric finishing processes are wet processes. In a water repellent treatment of the fabric, the fabric is immersed in a hydrophobic finishing agent (typically referred as a hydrophobic agent), then the fabric is pressed by rollers to infiltrate the hydrophobic agent into the inner of the fabric, and the hydrophobic agent is introduced into and adhered to the fabric by a high temperature baking treatment.

However, in the immersion process, the concentration of the hydrophobic agent has to be kept in a certain concentration range. If the hydrophobic agent is too dilute, the hydrophobic agent needs to be replaced immediately. Thus, the immersion process has a disadvantage of a low utilization ratio of the hydrophobic agent and a problem of treating a waste hydrophobic agent. In addition, the oven uses several tubes, such that the high temperature baking treatment has problems of power consumption and waste heat generated by the tubes. Furthermore, in order to meet capacity requirements, the oven needs to have a certain length, such that the oven occupies a larger space.

As the environmental awareness is increasing, the government is increasingly strict with the controlling of the contamination and the waste generated in the industrial processes. Thus, it is desirable to solve the problems of waste liquid and power consumption occurred in the traditional fabric finishing processes.

### SUMMARY

Therefore, one objective of the present invention is to provide a hydrophobic finishing apparatus of a fabric, which uses a spray coating device to spray a hydrophobic agent to the fabric, such that the hydrophobic agent is uniformly distributed on a surface of the fabric, and a problem of a traditional immersion method that the hydrophobic agent is getting diluter is prevented. Thus, a utilization ratio of the hydrophobic agent is increased.

Another objective of the present invention is to provide a hydrophobic finishing apparatus of a fabric, which can significantly enhance a utilization ratio of a hydrophobic agent, thereby can effectively solve a problem of treating a waste hydrophobic agent.

Still another objective of the present invention is to provide a hydrophobic finishing apparatus of a fabric, which uses a plasma device to perform a plasma treatment on a fabric which is coated with a hydrophobic agent, so as to promote the polymerization of hydrophobic monomers in the hydrophobic agent, and the bonding of the hydrophobic monomers or the polymers with a surface of the fabric, thereby increasing a laundry resistant of the fabric.

Yet another objective of the present invention is to provide a hydrophobic finishing apparatus of a fabric, in which a plasma treatment performed on the fabric by a plasma device of the hydrophobic finishing apparatus can shorten a baking duration of the fabric or can eliminate a baking treatment, thereby greatly reducing the power consumption and the power expense, and effectively decreasing the waste heat.

According to the aforementioned objectives, the present invention provides a hydrophobic finishing apparatus of a fabric, which is suitable to perform a hydrophobic finishing on the fabric. The hydrophobic finishing apparatus of the fabric includes a first spray coating device, at least one first plasma device, a second spray coating device, and at least one second plasma device. The first spray coating device is configured to spray a hydrophobic agent to a first side of the fabric. The first plasma device is disposed at the rear of the first spray coating device, and is configured to perform a first plasma treatment on the first side of the fabric. The second spray coating device is disposed at the rear of the at least one first plasma device, and is configured to spray the hydrophobic agent to a second side of the fabric, in which the second side is opposite to the first side. The second plasma device is disposed at the rear of the second spray coating device, and is configured to perform a second plasma treatment on the second side of the fabric.

According to one embodiment of the present invention, the hydrophobic finishing apparatus of the fabric further includes an oven, in which the oven is disposed at the rear of the second plasma device, and is configured to perform a baking treatment on the fabric.

According to one embodiment of the present invention, the first spray coating device is a fluid spray coating device.

According to one embodiment of the present invention, the second spray coating device is a fluid spray coating device.

According to one embodiment of the present invention, the first plasma device is a wide range plasma device.

According to one embodiment of the present invention, the second plasma device is a wide range plasma device.

According to one embodiment of the present invention, a number of the at least one first plasma device is in a range from 1 to 10.

According to one embodiment of the present invention, a number of the at least one second plasma device is in a range from 1 to 10.

### BRIEF DESCRIPTION OF THE DRAWINGS

The invention can be more fully understood by reading the following detailed description of the embodiment, with reference made to the accompanying drawings as follows:

FIG. 1 is a schematic drawing of a hydrophobic finishing apparatus of a fabric in accordance with one embodiment of the present invention.

### DETAILED DESCRIPTION

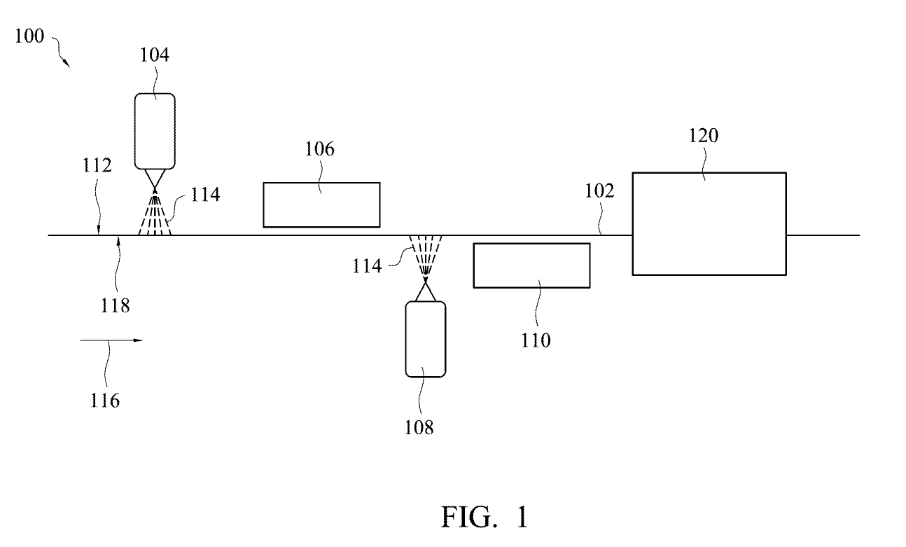

Referring to FIG. 1, FIG. 1 is a schematic drawing of a hydrophobic finishing apparatus of a fabric in accordance with one embodiment of the present invention. A hydrophobic finishing apparatus 100 of a fabric of the present embodiment may be suitable to perform hydrophobic finishing on a fabric 102. In some examples, the hydrophobic finishing apparatus 100 mainly includes a first spray coating device 104, at least one first plasma device 106, a second spray coating device 108, and at least one second plasma device 110. The first spray coating device 104 is adjacent to a first side 112 of the fabric 102, and is configured to spray a hydrophobic agent 114 to the first side 112 of the fabric 102. For example, the first spray coating device 104 may be a fluid spray coating device.

The first plasma device 106 is disposed at the rear of the first spray coating device 104. That is the fabric 102 moves along a direction 116, the first plasma device 106 is located at the back of the first spray coating device 104 according to the direction 116 which the fabric 102 moves along. The first plasma device 106 is configured to perform a first plasma treatment on the first side 112 of the fabric 102 which is coated with the hydrophobic agent 114. In the first plasma treatment, the plasma can make hydrophobic monomers polymerize with each other, and the plasma also can form dangling bonds on a surface on the first side 112 of the fabric 102, such that the hydrophobic monomers or polymers of the hydrophobic monomers can bond with the dangling bonds on the surface of the fabric 102, and thus the hydrophobic monomers or the polymers can be firmly adhered to the surface of the fabric 102. Therefore, the plasma treatment can enhance a laundry resistant of the fabric 102. In some exemplary examples, the first plasma device 106 is a wide range plasma device.

In the exemplary example shown in FIG. 1, the hydrophobic finishing apparatus 100 includes one first plasma device 106, such that as the fabric 102 is conveyed forwards along the direction 116, the first plasma device 106 can perform one first plasma treatment on every region of the first side 112 of the fabric 102. In some examples, the hydrophobic finishing apparatus 100 includes various first plasma devices 106, in which the first plasma devices 106 may be sequentially arranged along the direction 116. The first plasma devices 106 can respectively perform one first plasma treatment on every region of the fabric 102, such that the first plasma devices 106 collectively perform many first plasma treatments on the same region of the fabric 102. For example, a number of the first plasma devices 106 of the hydrophobic finishing apparatus 100 may be in a range from 1 to 10, and the first plasma devices 106 can collectively perform the first plasma treatment on every region of the first side 112 of the fabric 102 for 1 time to 10 times. The number of the plasma devices can determine the treating speed.

The second spray coating device 108 may be adjacent to a second side 118 of the fabric 102. The second spray coating device 108 is located at the rear of the first plasma device 106, that is, the second spray coating device 108 is located at the back of the first plasma device 106 according to the direction 116 which the fabric 102 moves along. The second spray coating device 108 is configured to spray the hydrophobic agent 114 to the second side 118 of the fabric 102, in which the second side 118 and the first side 112 of the fabric 102 are opposite to each other. For example, the second spray coating device 108 may be a fluid spray coating device.

The second plasma device 110 is disposed at the rear of the second spray coating device 108, that is, the second plasma device 110 is located at the back of the second spray coating device 108 according to the direction 116 which the fabric 102 moves along. The second plasma device 110 is configured to perform a second plasma treatment on the second side 118 of the fabric 102 which is coated with the hydrophobic agent 114. In the second plasma treatment, the plasma can make hydrophobic monomers polymerize with each other, and the plasma also can form dangling bonds on a surface on the second side 118 of the fabric 102, such that the hydrophobic monomers or polymers of the hydrophobic monomers can bond with the dangling bonds on the surface of the fabric 102, and thus the hydrophobic monomers or the polymers can be firmly adhered to the surface of the fabric 102. Therefore, the plasma treatment can enhance a laundry resistant of the fabric 102. In some exemplary examples, the second plasma device 110 is a wide range plasma device.

In the exemplary example shown in FIG. 1, the hydrophobic finishing apparatus 100 includes one second plasma device 110, such that as the fabric 102 is conveyed forwards along the direction 116, the second plasma device 110 can perform one second plasma treatment on every region of the second side 118 of the fabric 102. In some examples, the hydrophobic finishing apparatus 100 includes various second plasma devices 110, in which the second plasma devices 110 may be sequentially arranged along the direction 116. The second plasma devices 110 can respectively perform one second plasma treatment on every region of the fabric 102, such that the second plasma devices 110 collectively perform many second plasma treatments on the same region of the fabric 102. For example, a number of the second plasma devices 110 of the hydrophobic finishing apparatus 100 may be in a range from 1 to 10, and the second plasma devices 110 can collectively perform the second plasma treatment on every region of the second side 118 of the fabric 102 for 1 time to 10 times. The number of the plasma devices can determine the treating speed.

Referring to FIG. 1 again, in some examples, the hydrophobic finishing apparatus 100 may further optionally include an oven 120. The oven 120 is disposed at the rear of the second plasma device 110, that is, the oven 120 is located at the back of the second plasma device 110 according to the direction 116 which the fabric 102 moves along. The oven 120 is configured to perform a baking treatment on the fabric 102, in which two sides of the fabric 102 have been coated with the hydrophobic agent 114 and treated by the plasma, so as to introduce the hydrophobic agent 114 further into the fabric 102. In some exemplary examples, the fabric 102 may be baked within the oven 120 under a temperature ranging from about 120 degrees centigrade to about 160 degrees centigrade for a duration ranging from 0 second to about 60 seconds. That is the fabric 102 may not be baked, or may be baked for a duration which is smaller than or equal to about 60 seconds.

In the present embodiment, the first side 112 and the second side 118 of the fabric 102 are coated with the hydrophobic agent 114 and then are treated by the plasma, such that the baking duration of the fabric 102 is greatly reduced, even the fabric 102 may not need to be baked by the oven 120. Therefore, the power expense is decreased, and the waste heat is reduced.

An AATCC22 water repellency spray test is performed on the fabric 102 which is finished by the hydrophobic finishing apparatus 100 of the present embodiment. The test result shows that the water repellency spray test of the baked fabric 102 after 20 times washing remains on grade 5, and the water repellency spray test of the unbaked fabric 102 after 20 times washing remains on grade 4. Thus, the fabric 102 finished by the hydrophobic finishing apparatus 100 of the present embodiment has a good laundry resistant, even when the fabric 102 is not baked.

According to the aforementioned embodiments, one advantage of the present invention is that a hydrophobic finishing apparatus of a fabric of the present invention uses a spray coating device to spray a hydrophobic agent to the fabric, such that the hydrophobic agent is uniformly distributed on a surface of the fabric, and a problem of a traditional immersion method that the hydrophobic agent is getting diluter is prevented. Thus, a utilization ratio of the hydrophobic agent is increased, the cost of the hydrophobic agent is decreased, and a problem of treating a waste hydrophobic agent is effectively solved.

According to the aforementioned embodiments, another advantage of the present invention is that a hydrophobic finishing apparatus of a fabric of the present invention uses a plasma device to perform a plasma treatment on a fabric which is coated with a hydrophobic agent to promote the polymerization of hydrophobic monomers in the hydrophobic agent, and the bonding of the hydrophobic monomers or the polymers with a surface of the fabric, thereby increasing a laundry resistant of the fabric.

According to the aforementioned embodiments, still another advantage of the present invention is that a plasma treatment performed on the fabric by a plasma device of a hydrophobic finishing apparatus of the fabric can shorten a baking duration of the fabric or can eliminate a baking treatment, thereby greatly reducing the power consumption and the power expense and effectively decreasing the waste heat.

Although the present invention has been described in considerable detail with reference to certain embodiments thereof, the foregoing embodiments of the present invention are illustrative of the present invention rather than limiting of the present invention. It will be apparent to those having ordinary skill in the art that various modifications and variations can be made to the present invention without departing from the scope or spirit of the invention. Therefore, the spirit and scope of the appended claims should not be limited to the description of the embodiments contained herein.

What is claimed is:

1. A hydrophobic finishing apparatus of a fabric which is suitable to perform a hydrophobic finishing on the fabric, and the hydrophobic finishing apparatus of the fabric comprising:
a first spray coating device configured to spray a hydrophobic agent to a first side of the fabric;
at least one first plasma device disposed at the rear of the first spray coating device, and configured to perform a first plasma treatment on the first side of the fabric;
a second spray coating device disposed at the rear of the at least one first plasma device, and configured to spray the hydrophobic agent to a second side of the fabric, wherein the second side is opposite to the first side; and
at least one second plasma device disposed at the rear of the second spray coating device, and configured to perform a second plasma treatment on the second side of the fabric.

2. The hydrophobic finishing apparatus of the fabric of claim 1, further comprising an oven disposed at the rear of the at least one second plasma device, and configured to perform a baking treatment on the fabric.

3. The hydrophobic finishing apparatus of the fabric of claim 1, wherein the first spray coating device is a fluid spray coating device.

4. The hydrophobic finishing apparatus of the fabric of claim 1, wherein the second spray coating device is a fluid spray coating device.

5. The hydrophobic finishing apparatus of the fabric of claim 1, wherein the at least one first plasma device is a wide range plasma device.

6. The hydrophobic finishing apparatus of the fabric of claim 1, wherein the at least one second plasma device is a wide range plasma device.

7. The hydrophobic finishing apparatus of the fabric of claim 1, wherein a number of the at least one first plasma device is in a range from 1 to 10.

8. The hydrophobic finishing apparatus of the fabric of claim 1, wherein a number of the at least one second plasma device is in a range from 1 to 10.
